(19) United States
(12) Patent Application Publication
(10) Pub. No.: US 2020/0040243 A1
(43) Pub. Date: Feb. 6, 2020

(54) QUASI-AZEOTROPIC COMPOSITION COMPRISING 2,3,3,3-TETRAFLUOROPROPENE AND TRANS-1,3,3,3-TETRAFLUOROPROPENE

(71) Applicant: ARKEMA FRANCE, Colombes (FR)

(72) Inventors: Wissam RACHED, Chaponost (FR); Dominique DEUR-BERT, Charly (FR); Laurent WENDLINGER, Soucieu En Jarrest (FR)

(73) Assignee: ARKEMA FRANCE, Colombes (FR)

(21) Appl. No.: 16/491,878

(22) PCT Filed: Mar. 9, 2018
(86) PCT No.: PCT/FR2018/050555

§ 371 Date: Sep. 6, 2019

(30) Foreign Application Priority Data
Mar. 10, 2017 (FR) 1751958

(51) Int. Cl. C09K 5/04; F01K 25/00; F25B 13/00

(52) U.S. Cl. CPC C09K 5/048; C09K 5/045; F01K 25/00; C09K 2205/22; C09K 2205/32; C09K 2205/126; F25B 13/00

(57) ABSTRACT

The present invention relates to a quasi-azeotropic composition comprising from 60 mol % to 99.9 mol % of 2,3,3,3-tetrafluoropropene and from 0.1 mol % to 40 mol % of trans-1,3,3,3-tetrafluoropropene relative to the total number of moles of the composition, said quasi-azeotropic composition having a boiling point of between 45° C. and 80° C., at a pressure of between 1 and 50 bar abs, preferably between 12 and 20 bar abs. The present invention also relates to the use of said composition in heat transfer applications.

### TECHNICAL FIELD

The present invention relates to compositions comprising 2,3,3,3-tetrafluoropropene and trans-1,3,3,3-tetrafluoropropene, useful in a number of fields of application.

### TECHNOLOGICAL BACKGROUND

The problems posed by substances depleting the atmospheric ozone layer were examined in Montreal, where the protocol imposing a reduction of the production and the use of chlorofluorocarbons (CFCs) was signed. This protocol was the subject of amendments that have imposed abandoning CFCs and have extended the regulations to other products, including hydrochlorofluorocarbons (HCFCs).

The refrigeration and air conditioning industry has invested a lot in substituting these refrigerant fluids and this is why hydrofluorocarbons (HFCs) have been commercialised.

In the automotive industry, air conditioning systems of vehicles commercialised in numerous countries have passed from a chlorofluorocarbon (CFC-12) refrigerant fluid to a hydrofluorocarbon (1,1,1,2-tetrafluoroethane: HFC-134a) refrigerant fluid, which is less harmful to the ozone layer. However, regarding the aims set by the Kyoto protocol, HFC-134a (GWP=1430) is considered as having an increased warming power. The contribution to the greenhouse effect of a fluid is quantified by one criterion, the GWP (Global Warming Potential), which summarises the warming power by taking a reference value of 1 for carbon dioxide.

Carbon dioxide, being non-toxic, fireproof and having a very low GWP, has been proposed as a refrigerant fluid of air conditioning systems, replacing HFC-134a. However, using carbon dioxide has several disadvantages, in particular linked to the very high pressure of the implementation thereof as a refrigerant fluid in existing appliances and technologies.

Document JP 4110388 describes the use of hydrofluoropropenes of formula C₃HₘFₙ, with m, n representing an integer of between 1 and 5 inclusive, and m+n=6, as heat transfer fluids, in particular tetrafluoropropene and trifluoropropene.

Document WO 2004/037913 discloses the use of compositions comprising at least one fluoroalkene having three or four carbon atoms, in particular pentafluoropropene and tetrafluoropropene, preferably having a GWP of at most of 150, as heat transfer fluids.

Document WO 2005/105947 discloses the addition of tetrafluoropropene, preferably 1,3,3,3-tetrafluoropropene, of an expansion co-agent, such as difluoromethane (HFC-32), pentafluoroethane (HFC-125), tetrafluoroethane, difluoroethane, heptafluoropropane, hexafluoropropane, pentafluoropropane, pentafluorobutane, water and carbon dioxide.

Document WO 2006/094303 discloses an azeotropic composition containing 70.4% by weight of 2,3,3,3-tetrafluoropropene (1234yf) and 29.6% by weight of 1,1,1,2-tetrafluoroethane (HFC-134a). This document also discloses an azeotropic composition containing 91% by weight of 2,3,3,3-tetrafluoropropene and 9% by weight of difluoroethane (HFC-152a).

US 2006/243944 describes a quasi-azeotropic composition consisting of 1-99% of HFO-1234yf and 99-1% of trans-HFC-1234ze at −25° C. WO 2010/129920 describes refrigerant compositions comprising R32, R125, R134a, 1234ze and 1234yf in different proportions.

There is a need to find new compositions making it possible, in particular to overcome at least one of the abovementioned disadvantages, and having in particular a zero ODP and a GWP less than that of existing HFCs, such as R407C or R134a.

### DESCRIPTION OF THE INVENTION

The present invention relates to a quasi-azeotropic composition comprising (preferably consisting of) 60 mol % to 99.9 mol % of 2,3,3,3-tetrafluoropropene, and 0.1 mol % to 40 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 10 and 40 bar abs, most preferably between 12 and 20 bar abs.

According to one embodiment, the present invention relates to a quasi-azeotropic composition comprising (preferably consisting of) 60 mol % to 98.9 mol % of 2,3,3,3-tetrafluoropropene, and 1.1 mol % to 40 mol % of trans-1,3,3,3-terafluoropropene, relative to the total number of moles of the composition, preferably 71 mol % to 98.9 mol % of 2,3,3,3-tetrafluoropropene, and 1.1 mol % to 29 mol % of trans-1,3,3,3-tetrafluoropropene, and advantageously 71 mol % to 98 mol % of 2,3,3,3-tetrafluoropropene, and 2 mol % to 29 mol % of trans-1,3,3,3-tetrafluoropropene, said quasi-azeotropic composition having a boiling point of between 45° C. and 80° C., at a pressure of between 1 and 50 bar abs, preferably between 10 and 40 bar abs, preferably between 12 and 20 bar abs.

Unless otherwise specified, in the whole application, the compound proportions indicated are given as molar percentages.

In the context of the invention, “HFO-1234yf” refers to 2,3,3,3-tetrafluoropropene.

In the context of the invention, “trans-HFO-1234ze” refers to trans-1,3,3,3-tetrafluoropropene.

In the context of the invention, the terms “of between x and y” or “from x to y”, or “comprises from x to y” are used to describe a range wherein the limits x and y are inclusive. For example, the range “of between 0 and 0.5%” includes, in particular, the values 0 and 0.5%.

In the context of the invention, by “abs”, is meant “absolute”.

The volatility of a compound A is represented by the ratio of the molar fraction in the gaseous phase (y_{A}) over the molar fraction in the liquid phase (x_{A}) under conditions of equilibrium (at the pressure and temperature equilibrium): α=y_{A}/x_{A}. The volatility of a compound B is represented by the ratio of the molar fraction in the gaseous phase (y_{B}) over the molar fraction in the liquid phase (x_{B}) under conditions of equilibrium (at the pressure and temperature equilibrium): α=y_{B}/x_{B}.

The relative volatility makes it possible, in particular, to measure the ease of separation of two compounds A and B. It is the ratio of the volatilities of the 2 compounds: α_{A, B}=y_{A}x_{B}/x_{A}y_{B}. In particular, the higher the volatility, the more the mixture is easily separable.

In the context of the invention, when the relative volatility of a mixture is between 0.95 and 1.05, this means that the mixture is azeotropic.

In the context of the invention, when the relative volatility is between 0.85 and 0.95 (0.95 being excluded), or between 1.05 (1.05 being excluded) and 1.15, this means that the mixture is quasi-azeotropic.

The compositions according to the invention can be prepared by any known method, such as for example, by simple mixture of different compounds with one another.

The compositions of the invention advantageously have a zero ODP and a GWP lower than existing HFCs. In addition, these compositions advantageously have better energy performances than those of existing HFCs, and in particular than those of R134a.

The quasi-azeotropic compositions according to the invention can advantageously be used to replace R134a, in particular in existing installations, for example in heat pumps.

These compositions advantageously have a very low flammability or are non-flammable at 23° C. and will advantageously be classified as non-flammable for transport.

In the context of the present application, flammability is defined in reference to the standard ASHRAE 34-2007. More specifically, the flammability of a heat transfer fluid at 50% relative humidity is determined according to the test appearing in the standard ASHRAE 34-2007 (which refers to the standard ASTM E681 regarding the equipment used).

Furthermore, the compositions according to the invention can advantageously be used at high condensation temperatures thanks to the low overheating at the output of the compressor.

According to an embodiment, the quasi-azeotropic composition according to the invention comprises:
70 mol % to 99.9 mol % of 2,3,3,3-tetrafluoropropene, and 0.1 mol % to 30 mol % of trans-1,3,3,3-tetrafluoropropene;
preferably, 70 mol % to 98.9 mol % of 2,3,3,3-tetrafluoropropene, and 1.1 mol % to 30 mol % of trans-1,3,3,3-tetrafluoropropene;
preferably, 71 mol % to 98 mol % of 2,3,3,3-tetrafluoropropene, and 2 mol % to 29 mol % of trans-1,3,3,3-tetrafluoropropene;
preferably, 75 mol % to 98 mol % of 2,3,3,3-tetrafluoropropene, and 2 mol % to 25 mol % of trans-1,3,3,3-tetrafluoropropene;
preferably, 80 mol % to 99.9 mol % of 2,3,3,3-tetrafluoropropene, and 0.1 mol % to 20 mol % of trans-1,3,3,3-tetrafluoropropene;
preferably, 80 mol % to 98 mol % of 2,3,3,3-tetrafluoropropene, and 2 mol % to 20 mol % of trans-1,3,3,3-tetrafluoropropene;
preferably, 85 mol % to 95 mol % of 2,3,3,3-tetrafluoropropene, and 5 mol % to 15 mol % of trans-1,3,3,3-tetrafluoropropene;
preferably, 88 mol % to 93 mol % of 2,3,3,3-tetrafluoropropene, and 7 mol % to 12 mol % of trans-1,3,3,3-tetrafluoropropene.

According to one embodiment, the quasi-azeotropic composition has a boiling point of between 50° C. and 75° C., preferably between 55° C. and 70° C., preferentially between 55° C. and 65° C., and in particular between 58° C. and 62° C.; in particular, at a pressure of between 1 and 50 bar abs, preferably between 10 and 40 bar abs, preferentially between 12 and 20 bar abs, preferably between 12 and 17 bar abs (±0.5%), preferentially between 15 and 17 bar abs (±0.5%).

According to one embodiment, the quasi-azeotropic composition comprises (preferably consists of) 70 mol % to 99.9 mol % of 2,3,3,3-tetrafluoropropene, and 0.1 mol % to 30 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 71 mol % to 98 mol % of 2,3,3,3-tetrafluoropropene, and 2 mol % to 29 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 75 mol % to 98 mol % of 2,3,3,3-tetrafluoropropene, and 2 mol % to 25 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 80 mol % to 99.9 mol % of 2,3,3,3-tetrafluoropropene, and 0.1 mol % to 20 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 80 mol % to 98 mol % of 2,3,3,3-tetrafluoropropene, and 2 mol % to 20 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 85 mol % to 95 mol % of 2,3,3,3-tetrafluoropropene, and 5 mol % to 15 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 88 mol % to 93 mol % of 2,3,3,3-tetrafluoropropene, and 7 mol % to 12 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to one embodiment, the quasi-azeotropic composition comprises (preferably consists of) 60 mol % to 99.9 mol % of 2,3,3,3-tetrafluoropropene, and 0.1 mol % to 40 mol % of trans-1,3,3,3-tetrafluoropropene, relative to the total number of moles of the composition, said quasi-azeotropic composition having a boiling point of between 45° C. and 80° C., at a pressure of between 1 and 50 bar abs, preferably between 12 and 20 bar abs.

According to a preferred embodiment, the quasi-azeotropic composition comprises 60 mol % to 99.9 mol % of 2,3,3,3-tetrafluoropropene, and 0.1 mol % to 40 mol % of trans-1,3,3,3-tetrafluoropropene, advantageously 70 mol % to 99.9 mol % of 2,3,3,3-tetrafluoropropene and 0.1 mol % to 30 mol % of trans-1,3,3,3-tetrafluoropropene, preferentially 80 mol % to 99 mol % of 2,3,3,3-tetrafluoropropene and 1 mol % to 20 mol % of trans-1,3,3,3-tetrafluoropropene, more preferentially 80 mol % to 98 mol % of 2,3,3,3-tetrafluoropropene and 2 mol % to 20 mol % of trans-1,3,3,3-tetrafluoropropene, even more preferably 85 mol % to 95 mol % of 2,3,3,3-tetrafluoropropene and 5 mol % to 15 mol % of trans-1,3,3,3-tetrafluoropropene, in particular 88 mol % to 93 mol % of 2,3,3,3-tetrafluoropropene and 7 mol % to 12 mol % of trans-1,3,3,3-tetrafluoropropene, said quasi-azeotropic composition having a boiling point of between 50° C. and 75° C., at a pressure of between 1 and 50 bar abs, preferably between 12 and 20 bar abs, preferably between 12 and 17 bar abs (±0.5%), preferentially between 15 and 17 bar abs (±0.5%).

According to a preferred embodiment, the quasi-azeotropic composition comprises 60 mol % to 99.9 mol % of 2,3,3,3-tetrafluoropropene, and 0.1 mol % to 40 mol % of trans-1,3,3,3-tetrafluoropropene, advantageously 70 mol % to 99.9 mol % of 2,3,3,3-tetrafluoropropene and 0.1 mol % to 30 mol % of trans-1,3,3,3-tetrafluoropropene, preferably 80 mol % to 99 mol % of 2,3,3,3-tetrafluoropropene and 1 mol % to 20 mol % of trans-1,3,3,3-tetrafluoropropene, more preferentially 80 mol % to 98 mol % of 2,3,3,3-tetrafluoropropene and 2 mol % to 20 mol % of trans-1,3,3,3-tetrafluoropropene, even more preferentially 85 mol % to 95 mol % of 2,3,3,3-tetrafluoropropene and 5 mol % to 15 mol % of trans-1,3,3,3-tetrafluoropropene, in particular 88 mol % to 93 mol % of 2,3,3,3-tetrafluoropropene and 7 mol % to 12 mol % of trans-1,3,3,3-tetrafluoropropene, said quasi-azeotropic composition having a boiling point of between 50° C. and 70° C., at a pressure of between 1 and 50 bar abs, preferably between 12 and 20 bar abs, preferably between 12 and 17 bar abs (±0.5%), preferentially between 15 and 17 bar abs (±0.5%).

According to a preferred embodiment, the quasi-azeotropic composition comprises 60 mol % to 99.9 mol % of 2,3,3,3-tetrafluoropropene, and 0.1 mol % to 40 mol % of trans-1,3,3,3-tetrafluoropropene, advantageously 70 mol % to 99.9 mol % of 2,3,3,3-tetrafluoropropene and 0.1 mol % to 30 mol % of trans-1,3,3,3-tetrafluoropropene, preferably 80 mol % to 99 mol % of 2,3,3,3-tetrafluoropropene and 1 mol % to 20 mol % of trans-1,3,3,3-tetrafluoropropene, more preferentially 80 mol % to 98 mol % of 2,3,3,3-tetrafluoropropene and 2 mol % to 20 mol % of trans-1,3,3,3-tetrafluoropropene, even more preferentially 85 mol % to 95 mol % of 2,3,3,3-tetrafluoropropene and 5 mol % to 15 mol % of trans-1,3,3,3-tetrafluoropropene, in particular 88 mol % to 93 mol % of 2,3,3,3-tetrafluoropropene and 7 mol % to 12 mol % of trans-1,3,3,3-tetrafluoropropene, said quasi-azeotropic composition having a boiling point of between 55° C. and 65° C., at a pressure of between 1 and 50 bar abs, preferably between 12 and 20 bar abs, preferably between 12 and 17 bar abs (±0.5%), preferentially between 15 and 17 bar abs (±0.5%).

According to a preferred embodiment, the quasi-azeotropic composition comprises 60 mol % to 99.9 mol % of 2,3,3,3-tetrafluoropropene, and 0.1 mol % to 40 mol % of trans-1,3,3,3-tetrafluoropropene, advantageously 70 mol % to 99.9 mol % of 2,3,3,3-tetrafluoropropene and 0.1 mol % to 30 mol % of trans-1,3,3,3-tetrafluoropropene, preferably 80 mol % to 99 mol % of 2,3,3,3-tetrafluoropropene and 1 mol % to 20 mol % of trans-1,3,3,3-tetrafluoropropene, more preferentially 80 mol % to 98 mol % of 2,3,3,3-tetrafluoropropene and 2 mol % to 20 mol % of trans-1,3,3,3-tetrafluoropropene, even more preferentially 85 mol % to 95 mol % of 2,3,3,3-tetrafluoropropene and 5 mol % to 15 mol % of trans-1,3,3,3-tetrafluoropropene, in particular 88 mol % to 93 mol % of 2,3,3,3-tetrafluoropropene and 7 mol % to 12 mol % of trans-1,3,3,3-tetrafluoropropene, said quasi-azeotropic composition having a boiling point of between 58° C. and 62° C., at a pressure of between 1 and 50 bar abs, preferably between 12 and 20 bar abs, preferably between 12 and 17 bar abs (±0.5%), preferentially between 15 and 17 bar abs (±0.5%).

According to a preferred embodiment, the quasi-azeotropic composition according to the invention comprises (preferably consists of) 64 mol % to 95 mol % of 2,3,3,3-tetrafluoropropene and 5 mol % to 36 mol % of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consists of) 64 mol % to 94 mol % of 2,3,3,3-tetrafluoropropene and 6 mol % to 36 mol % of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 65 mol % (±3%) of 2,3,3,3-tetrafluoropropene and 35 mol % (±3%) of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 75 mol % (±3%) of 2,3,3,3-tetrafluoropropene and 25 mol % (±3%) of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 80 mol % (±3%) of 2,3,3,3-tetrafluoropropene and 20 mol % (±3%) of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 86 mol % (±3%) of 2,3,3,3-tetrafluoropropene and 14 mol % (±3%) of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 90 mol % (±3%) of 2,3,3,3-tetrafluoropropene and 10 mol % (±3%) of trans-1,3,3,3-tetrafluoropropene, said composition having a boiling point of 60° C. (±0.1° C.), at a pressure of between 15 and 17 bar abs (±0.5%).

According to a preferred embodiment, the quasi-azeotropic composition according to the invention comprises (preferably consisting of) 92 mol % (±3%) of 2,3,3,3-tetrafluoropropene and 8 mol % (±3%) of trans-1,3,3,3-tetrafluoropropene, said composition having a boiling point of 60° C. (±0.1° C.), at a pressure of between 15 and 17 bar abs (±0.5%).

Heat Transfer Composition

According to an embodiment, the azeotropic composition of the invention is a heat transfer fluid.

The azeotropic composition according to the invention can comprise one or more additives (which are not essentially heat transfer compounds for the considered application).

The additives can in particular be selected from nanoparticles, stabilisers, surfactants, tracing agents, fluorescent agents, odorant agents, lubricants and solubilisation agents.

The terms “heat transfer compound”, respectively, “heat transfer fluid” or “refrigerant fluid” are used to describe a compound, respectively a fluid, likely to absorb heat by being evaporated at a low temperature and low pressure and to repel heat by condensing at a high temperature and at a high pressure, in a steam compression circuit. Generally, a heat transfer fluid can comprise just one, two, three or more than three heat transfer compounds.

The term “heat transfer composition” is used to describe a composition comprising a heat transfer fluid and possibly one or more additives, which are not heat transfer compounds for the considered application.

The present invention also relates to a heat transfer composition comprising (preferably consisting of) the azeotropic composition according to the abovementioned invention, and at least one additive, in particular selected from nanoparticles, stabilisers, surfactants, tracing agents, fluorescent agents, odorant agents, lubricants and solubilisation agents. Preferably, the additive is selected from lubricants, and in particular, polyol ester-based lubricants.

The stabiliser(s), when they are present, preferably represent at most 5% by mass of the heat transfer composition. Among stabilisers, in particular nitromethane, ascorbic acid, terephthalic acid, azoles such as tolutriazole or benzotriazole, phenolic compounds such as tocopherol, hydroquinone, t-butyl hydroquinone, 2,6-di-ter-butyl-4-methylphenol, epoxides (possibly fluorinated or perfluorinated or alkenyl or aromatic alkyl) such as n-butyl glycidyl ether, hexanediol diglycidyl ether, allyl glycidyl ether, butylphenylglycidyl ether, phosphites, phosphonates, thiols and lactones can be mentioned.

As nanoparticles, in particular carbon nanoparticles, metal oxides (copper, aluminium), TiO₂, Al₂O₃, MoS₂, etc. can be used.

As tracing agents (likely to be detected), deuterated (or not) hydrofluorocarbons, deuterated hydrocarbons, perfluorocarbons, fluoroethers, bromate compounds, iodised compounds, alcohols, aldehydes, ketones, nitrogen protoxide and combinations thereof can be mentioned. The tracing agent is different from the heat transfer compound(s) forming the heat transfer fluid.

As solubilisation agents, hydrocarbons, dimethylether, polyoxyalkylene ethers, amides, ketones, nitrides, chlorocarbons, esters, lactones, aryl ethers, fluoroethers and 1,1,1-trifluoroalkanes can be mentioned. The solubilisation agent is different to the heat transfer compound(s) forming the heat transfer fluid.

As fluorescent agents, naphthalimides, perylenes, coumarins, anthracenes, phenanthracenes, xanthenes, thioxanthenes, naphthoxanthenes, fluoresceins and derivatives and combinations thereof can be mentioned.

As odorant agents, alkylacrylates, allyacrylates, acrylic acids, acrylesters, alkylethers, alkylesters, alkynes, aldehydes, thiols, thioethers, disulphides, allylisothiocyanates, alkanoic acids, amines, norbornenes, derivatives of norbornenes, cyclohexene, heterocyclic aromatic compounds, ascaridole, o-methoxy(methyl)-phenol and combinations thereof can be mentioned.

In the context of the invention, the terms “lubricant”, “lubricating oil” and “lubrication oil” are used to mean the same thing.

As lubricants, in particular oils of mineral origin, silicone oils, natural origin paraffins, naphtenes, synthetic paraffins, alkylbenzenes, poly-alpha olefins, polyalkene glycols, polyol esters and/or polyvinyl ethers can be used.

Polyvinyl ether (PVE) oils are preferably copolymers of the 2 following motifs:

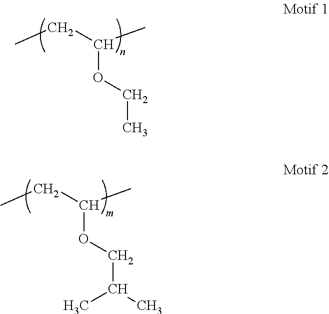

The properties of the oil (viscosity, solubility of the fluid and miscibility with the fluid, in particular) can be adjusted by making the ratio m/n and the sum m+n vary. Preferred PVE oils are those having 50 to 95% by weight of motifs 1.

According to one embodiment, the lubricant is polyol ester-based. In particular, the lubricant comprises one or more polyol ester(s).

According to one embodiment, the polyol esters are obtained by reaction of at least one polyol, with a carboxylic acid or with a mixture of carboxylic acids.

In the context of the invention, and unless otherwise specified, the term “polyol” is used to describe a compound containing at least two hydroxyl (—OH) groups.

Polyol Esters A)

According to one embodiment, the polyol esters according to the invention correspond to the following formula (I):

R¹[OC(O)R²]ₙ (I)

wherein:
R¹ is a hydrocarbon radical, linear or branched, possibly substituted by at least one hydroxyl group and/or comprising at least one heteroatom selected from the group consisting of —O—, —N—, and —S—;
each R² is, independently from one another, selected from the group consisting of:
   i) H;
   ii) an aliphatic hydrocarbon radical;
   iii) a branched hydrocarbon radical;
   iv) a mixture of a radical ii) and/or iii), with an aliphatic hydrocarbon radical comprising 8 to 14 carbon atoms; and
n is an integer of at least 2.

In the context of the invention, the term hydrocarbon radical is used to describe a radical composed of carbon and hydrogen atoms.

According to an embodiment, polyols have the following general formula (I):

R¹(OH)ₙ (11)

wherein:
R¹ is a hydrocarbon radical, linear or branched, possibly substituted by at least one hydroxyl group, preferably by two hydroxyl groups, and/or comprising at least one heteroatom selected from the group consisting of —O—, —N—, and —S—; and
n is an integer of at least 2.

Preferably, R¹ is a hydrocarbon radical, linear or branched, comprising 4 to 40 carbon atoms, preferably 4 to 20 carbon atoms.

Preferably, R¹ is a hydrocarbon radical, linear or branched, comprising at least one oxygen atom.

Preferably, R¹ is a branched hydrocarbon radical, comprising 4 to 10 carbon atoms, preferably 5 carbon atoms, substituted by two hydroxyl groups.

According to a preferred embodiment, the polyols comprise 2 to 10 hydroxyl groups, preferably 2 to 6 hydroxyl groups.

The polyols according to the invention can comprise one or more oxyalkylene groups, in this specific case, these are polyetherpolyols.

The polyols according to the invention can also comprise one or more nitrogen atoms. For example, the polyols can be alkanol amines containing 3 to 6 OH groups. Preferably, the polyols are alkanol amines containing at least two OH groups, and preferably at least three.

According to the present invention, the preferred polyols are selected from the group consisting of glycol ethylene, glycol diethylene, glycol triethylene, glycol propylene, glycol dipropylene, glycerol, glycol neopentyl, 1,2-butanediol, 1,4-butanediol, 1,3-butanediol, pentaerythritol, dipentaerythritol, tripentaerythritol, triglycerol, trimethylolpropane, sorbitol, hexaglycerol, and mixtures thereof.

According to the invention, the carboxylic acids can correspond to the following general formula (III):

R²COOH (III)

wherein:
R² is selected from the group consisting of:
   i) H;
   ii) an aliphatic hydrocarbon radical;
   iii) a branched hydrocarbon radical;
   iv) a mixture of a radical ii) and/or iii), with an aliphatic hydrocarbon radical comprising 8 to 14 carbon atoms.

Preferably, R² is an aliphatic hydrocarbon radical comprising 1 to 10, preferably 1 to 7 carbon atoms, and in particular, 1 to 6 carbon atoms.

Preferably, R² is a branched hydrocarbon radical, comprising 4 to 20 carbon atoms, in particular 5 to 14 carbon atoms, and preferably 6 to 8 carbon atoms.

According to a preferred embodiment, a branched hydrocarbon radical has the following formula (IV):

—C(R³)R⁴)(R⁵) (IV)

wherein R³, R⁴ and R⁵ are, independently from one another, an alkyl group, and at least one of the alkyl groups contains, as a minimum, two carbon atoms. Such branched alkyl groups, once linked to the carboxyl group, are known under the name, “neo group”, and the corresponding acid as “neo acid”. Preferably, R³ and R⁴ are methyl groups and R¹⁰ is an alkyl group comprising at least two carbon atoms.

According to the invention, the radical R² can comprise one or more carboxy groups, or ester groups, such as —COOR⁶, with R⁶ representing an alkyl, hydroxyalkyl radical, or a hydroxyalkyloxy alkyl group.

Preferably, the acid R²COOH of formula (III) is a monocarboxylic acid.

Examples of carboxylic acids, wherein the hydrocarbon radical is aliphatic are in particular: formic acid, acetic acid, propionic acid, butyric acid, pentanoic acid, hexanoic acid, and heptanoic acid.

Examples of carboxylic acids, wherein the hydrocarbon radical is branched are in particular: 2-ethyl-n-butyric acid, 2-hexyldecanoic acid, isosteric acid, 2-methyl-hexanoic acid, 2-methylbutanoic acid, 3-methlbutanoic acid, 3,5,5-trimethyl-hexanoic acid, 2-ethylhexanoic acid, neoheptanoic acid, neodecanoic acid.

The third type of carboxylic acids that can be used in preparing polyol esters of formula (I) are carboxylic acids comprising an aliphatic hydrocarbon radical comprising 8 to 14 carbon atoms. For example, the following can be mentioned: decanoic acid, dodecanoic acid, lauric acid, stearic acid, myristic acid, behenic acid, etc. From among dicarboxylic acids, maleic acid, succinic acid, adipic acid, sebacic acid, etc. can be mentioned.

According to a preferred embodiment, the carboxylic acids used to prepare polyol esters of formula (I) comprise a mixture of monocarboxylic and dicarboxylic acids, the proportion of monocarboxylic acids being majority. The presence of dicarboxylic acids in particular result in the formation of polyol esters of increased viscosity.

In particular, the formation reaction of polyol esters of formula (I) by reaction between carboxylic acid and polyols is a reaction catalysed by an acid. In particular, this is a reversible reaction, which can be complete by using a large quantity of acid or by eliminating water formed during the reaction.

The esterification reaction can be carried out in the presence of organic or inorganic acids, such as sulphuric acid, phosphoric acid, etc.

Preferably, the reaction is carried out in the absence of a catalyst.

The quantity of carboxylic acid and polyol can vary in the mixture according to the desired results. In the specific case where all hydroxyl groups are esterified, a sufficient quantity of carboxylic acid must be added to react with all the hydroxyls.

According to one embodiment, during the use of mixtures of carboxylic acids, these can react sequentially with polyols.

According to a preferred embodiment, during the use of a mixture of carboxylic acids, a polyol first reacts with a carboxylic acid, typically carboxylic acid of a higher molecular weight, followed by the reaction with carboxylic acid having an aliphatic hydrocarbon chain.

According to an embodiment, the esters can be formed by reaction between carboxylic acids (or the anhydride or ester derivatives thereof) with polyols, in the presence of acids at a high temperature, while removing the water formed during the reaction. Typically, the reaction can be carried out at a temperature of between 75 to 200° C.

According to another embodiment, the polyol esters formed can comprise hydroxyl groups not having all reacted, in this case, these are partially esterified polyol esters.

According to a preferred embodiment, polyol esters are obtained from pentaerythritol alcohol, and a mixture of carboxylic acids: isononanoic acid, at least one acid having an aliphatic hydrocarbon radical comprising 8 to 10 carbon atoms, and heptanoic acid. Preferred polyol esters are obtained from pentaerythritol, and a mixture of 70% of isononanoic acid, 15% of at least one carboxylic acid having an aliphatic hydrocarbon radical comprising 8 to 10 carbon atoms, and 15% of heptanoic acid. For example, Solest 68 oil, commercialised by CPI Engineering Services Inc. can be mentioned.

Polyol Esters B)

According to another embodiment, the polyol esters of the invention comprise at least one ester of one or more branched carboxylic acids comprising at most 8 carbon atoms. The ester is in particular obtained by reaction of said branched carboxylic acid with one or more polyols.

Preferably, the branched carboxylic acid comprises at least 5 carbon atoms. In particular, the branched carboxylic acid comprises 5 to 8 carbon atoms, and preferably it contains 5 carbon atoms.

Preferably, the abovementioned branched carboxylic acid does not comprise 9 carbon atoms. In particular, said carboxylic acid is not 3,5,5-trimethylhexanoic acid.

According to a preferred embodiment, the branched carboxylic acid is selected from 2-methylbutanoic acid, 3-methylbutanoic acid, and the mixtures thereof.

According to a preferred embodiment, polyol is selected from the group consisting of glycol neopentyl, glycerol, trimethylol propane, pentaerythritol, dipentaerythritol, tripentaerythritol, and the mixtures thereof.

According to a preferred embodiment, the polyol esters are obtained from:

i) a carboxylic acid selected from 2-methylbutanoic acid, 3-methylbutanoic acid, and the mixtures thereof; and

ii) a polyol selected from the group consisting of glycol neopentyl, glycerol, trimethylol propane, pentaerythritol, dipentaerythritol, tripentaerythritol, and the mixtures thereof.

Preferably, the polyol ester is that obtained from 2-methylbutanoic acid and pentaerythritol.

Preferably, the polyol ester is that obtained from 2-methylbutanoic acid and dipentaerythritol.

Preferably, the polyol ester is that obtained from 3-methylbutanoic acid and pentaerythritol.

Preferably, the polyol ester is that obtained from 3-methylbutanoic acid and dipentaerythritol.

Preferably, the polyol ester is that obtained from 2-methylbutanoic acid and glycol neopentyl.

Polyol Esters C)

According to another embodiment, the polyol esters according to the invention are poly(neopentylpolyol) esters obtained by:

i) reaction of a neopentylpolyol having the following formula (V):

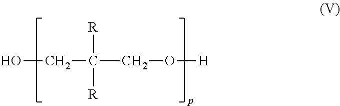

wherein:
each R represents, independently from one another, CH₃, C₂H₅ or CH₂OH;
p is an integer between 1 and 4;

with at least one monocarboxylic acid having 2 to 15 carbon atoms, and in the presence of an acid catalyst, the molar ratio between the carboxyl groups and the hydroxyl groups being less than 1:1, to form a partially esterified poly(neopentyl)polyol composition; and

ii) reaction of the partially esterified poly(neopentyl)polyol composition obtained from step i), with another carboxylic acid having 2 to 15 carbon atoms, to form the final composition of poly(neopentyl)polyol ester(s).

Preferably, the reaction i) is carried out with a molar ratio between 1:4 and 1:2. Preferably, the neopentylpolyol has the following formula (VI):

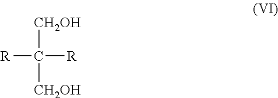

wherein each R represents, independently from one another, CH₃, C₂H₅ or CH₂OH.

Preferred neopentylpolyols are those selected from pentaerythritol, dipentaerythritol, tripentaerythritol, tetraerythritol, trimethylolpropane, trimethylolethane, and glycol neopentyl. In particular, the neopentylpolyol is pentaerythritol.

Preferably, one single neopentylpolyol is used to produce the POE-based lubricant. In certain cases, two or more neopentylpolyols are used. It is in particular the case when a commercial product of pentaerythritol comprises low quantities of dipentaerythritol, tripentaerythritol, and tetraerythritol.

According to a preferred embodiment, the abovementioned monocarboxylic acid comprises 5 to 11 carbon atoms, preferably 6 to 10 carbon atoms.

Monocarboxylic acids have, in particular, the following general formula (VII):

R′C(O)OH (VII)

wherein R′ is an alkyl radical, linear or branched, in C1-C12, an aryl radical in C6-C12, an aralkyl radical in C6-C30. Preferably, R′ is an alkyl radical in C4-C10, and preferably in C5-C9.

In particular, monocarboxylic acid is selected from the group consisting of butanoic acid, pentanoic acid, hexanoic acid, heptanoic acid, n-octanoic acid, n-nonanoic acid, n-decanoic acid, 3-methylbutanoic acid, 2-methylbutanoic acid, 2,4-dimethylpentanoic acid, 2-ethylhexanoic acid, 3,3,5-trimethylhexanoic acid, benzoic acid, and the mixtures thereof.

According to a preferred embodiment, monocarboxylic acid is n-heptanoic acid, or a mixture of n-heptanoic acid with another linear monocarboxylic acid, in particular n-octanoic acid and/or n-decanoic acid. Such a monocarboxylic acid mixture can comprise between 15 and 100 mol % of heptanoic acid and between 85 and 0 mol % of other monocarboxylic acid(s). In particular, the mixture comprises between 75 and 100 mol % of heptanoic acid, and between 25 and 0 mol % of a mixture of octanoic acid and decanoic acid in a molar ratio 3:2.

According to a preferred embodiment, the polyol esters comprise:

i) 45% to 55% by weight of a monopentaerythritol ester with at least one monocarboxylic acid having 2 to 15 carbon atoms;

ii) less than 13% by weight of a dipentaerythritol ester with at least one monocarboxylic acid having 2 to 15 carbon atoms;

iii) less than 10% by weight of a tripentaerythritol ester with at least one monocarboxylic acid having 2 to 15 carbon atoms; and

iv) at least 25% by weight of a tetraerythritol ester and other pentaerythritol oligomers, with at least one monocarboxylic acid having 2 to 15 carbon atoms.

Polyol Esters D)

According to another embodiment, the polyol esters according to the invention, have the following formula (VIII):

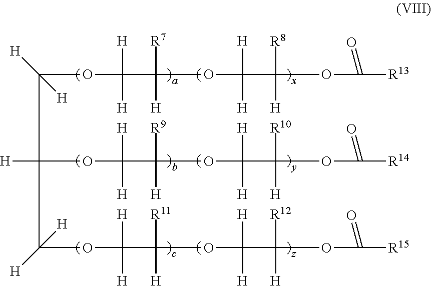

wherein:
R⁷, R⁸, R⁹, R¹⁰, R¹¹ and R¹² are, independently from one another, H or CH₃;
a, b, c, y, x and z are, independently from one another, an integer;
a+x, b+y, and c+z are, independently from one another, integers between 1 and 20;
R¹³, R¹⁴ and R¹⁵ are, independently from one another, selected from the group consisting of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalykls, arylakylcycloalkyls, cycloalkylalkylaryls and cycloalyklarylalkyls, R¹³, R¹⁴ and R¹⁵, having 1 to 17 carbon atoms, and could be possibly substituted.

According to a preferred embodiment, each of R¹³, R¹⁴ and R¹⁵ represents, independently from one another, a linear or branched alkyl group, an alkenyl group, a cycloalkyl group, said alkyl, alkenyl or cycloalkyl groups could comprise at least one heteroatom selected from N, O, Si, F or S. Preferably, each of R¹³, R¹⁴ and R¹⁵ has, independently from one another, 3 to 8 carbon atoms, preferably 5 to 7 carbon atoms.

Preferably, a+x, b+y, and c+z are, independently from one another, integers between 1 and 10, preferably between 2 and 8, and even more preferably, between 2 and 4.

Preferably, R⁷, R⁸, R⁹, R¹⁰, R¹¹ and R¹² represent H.

The polyol esters of formula (VIII) above can typically be prepared such as described in paragraphs [0027] to [0030] of international application WO 2012/177742.

In particular, the polyol esters of formula (VIII) are obtained by esterification of glycerol alkoxylates (such as described in paragraph [0027] of WO 2012/177742) with one or more monocarboxylic acids having 2 to 18 carbon atoms.

According to a preferred embodiment, the monocarboxylic acids have one of the following formulas:

R¹³COOH

R¹⁴COOH and

R¹⁵COOH

wherein R¹³, R¹⁴ and R¹⁵ are such as defined above. Derivatives of carboxylic acids can also be used, such as anhydrides, esters and acyl halides.

The esterification can be carried out with one or more monocarboxylic acids. Preferred monocarboxylic acids are those selected from the group consisting of acetic acid, propanoic acid, butyric acid, isobutanoic acid, pivalic acid, pentanoic acid, isopentanoic acid, hexanoic acid, heptanoic acid, octanoic acid, 2-ethylhexanoic acid, 3,3,5-trimethylhexanoic acid, nanonoic acid, decanoic acid, neodecanoic acid, undecanoic acid, dodecanoic acid, tridecanoic acid, myristic acid, pentadecanoic acid, palmitic acid, stearic acid, oleic acid, linoleic acid, palmitoleic acid, citronellic acid, undecanoic acid, behenic acid, tetrahydrobenzoic acid, hydrogenated (or not) abietic acid, 2-ethylhexanoic acid, furoic acid, benzoic acid, 4-acetylbenzoic acid, pyruvic acid, 4-tert-butyl-benzoic acid, naphthenic acid, 2-methyl benzoic acid, salicylic acid, the isomers thereof, the methyl esters thereof, and mixtures thereof.

Preferably, the esterification is carried out with one or more monocarboxylic acids selected from the group consisting of pentanoic acid, 2-methylbutanoic acid, n-hexanoic acid, n-heptanoic acid, 3,3,5-trimethylhexanoic acid, 2-ethylhexanoic acid, n-octanoic acid, n-nonanoic acid and isononanoic acid.

Preferably, the esterification is carried out with one or more monocarboxylic acids selected from the group consisting of butyric acid, isobutyric acid, n-pentanoic acid, 2-methylbutanoic acid, 3-methylbutanoic acid, n-hexanoic acid, n-heptanoic acid, n-octanoic acid, 2-ethylhexanoic acid, 3,3,5-trimethylhexanoic acid, n-nonanoic acid, decanoic acid, undecanoic acid, undecylenic acid, lauric acid, stearic acid, isosteric acid, and mixtures thereof.

According to another embodiment, the polyol esters according to the invention, have the following formula (IX):

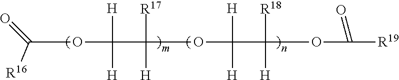

wherein:
each of R¹⁷ and R¹⁸ is, independently from one another, H or CH₃;
each of m and n is, independently from one another, an integer, with m+n, being an integer between 1 and 10;
R¹⁶ and R¹⁹ are, independently from one another, selected from the group consisting of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalkyls, arylalkylcycloalkyls, cycloalkylalryls and cycloalkylarylalkyls,

R¹⁶ and R¹⁹, having 1 to 17 carbon atoms, and could possibly be substituted.

According to a preferred embodiment, each of R¹⁶ and R¹⁹ represents, independently from one another, a linear or branched alkyl group, an alkenyl group, a cycloalkyl group, said alkyl, alkenyl or cycloalkyl groups possibly comprising at least one heteroatom selected from N, O, Si, F or S. Preferably, each of R¹⁶ and R¹⁹ has, independently from one another, 3 to 8 carbon atoms, preferably 5 to 7 carbon atoms.

According to a preferred embodiment, each of R¹⁷ and R¹⁸ represents H, and/or m+n is an integer between 2 and 8, 4 and 10, 2 and 5, or 3 and 5. In particular, m+n equals 2, 3 or 4.

According to a preferred embodiment, the polyol esters of formula (IX) above are glycol triethylene diesters, glycol tetraethylene diesters, in particular with one or two monocarboxylic acids having 4 to 9 carbon atoms.

The polyol esters of formula (IX) above can be prepared by esterification of a glycol ethylene, a glycol propylene, or an glycol oligo- or polyalkylene, (which can be a glycol oligo- or polyethylene, glycol oligo- or polypropylene, or a glycol glycol-propylene ethylene block copolymer), with one or two monocarboxylic acids having 2 to 18 carbon atoms. The esterification can be carried out identically to the esterification reaction implemented to prepare the polyol esters of formula (VIII) above.

In particular, monocarboxylic acids identical to those used to prepare the polyol esters of formula (VIII) above, can be used to form the polyol esters of formula (IX).

According to one embodiment, the polyol ester-based lubricant according to the invention comprises 20 to 80%, preferably 30 to 70%, and preferentially 40 to 60% by weight of at least one polyol ester of formula (VIII), and 80 to 20%, preferably 70 to 30%, and preferentially 60 to 40% by weight of at least one polyol ester of formula (IX).

Generally, certain alcohol functions cannot be esterified during the esterification reaction, however the proportion thereof remains low. Thus, the POEs can comprise between 0 and 5 mol % relating to CH₂OH motifs relative to the —CH₂—O—C(═O)— motifs.

The preferred POE lubricants according to the invention are those having a viscosity of 1 to 1000 centistokes (cSt) at 40° C., preferably 10 to 200 cSt, even more preferably 20 to 100 cSt, and advantageously 30 to 80 cSt.

The international classification of oils is in particular given by the standard, ISO3448-1992 (NF T60-141) and according to which the oils are named by the average viscosity class thereof measured at the temperature of 40° C.

According to one embodiment, the azeotropic composition content according to the invention in the heat transfer composition goes from 1 to 5% by weight: or 5 to 10%; or 10 to 15%; or 15 to 20%; or 20 to 25%; or 25 to 30%; or 30 to 35%; or 35 to 40%; or 40 to 45%; or 45 to 50%; or 50 to 55%; or 55 to 60%; or 60 to 65%; or 65 to 70%; or 70 to 75%; or 75 to 80%; or 80 to 85%; or 85 to 90%; or 90 to 95%; or 95 to 99%; or 99 to 99.5%; or 99.5 to 99.9%; or more than 99.9%, relative to the total weight of the heat transfer composition. The azeotropic composition content according to the invention can also vary in several of the ranges above: for example, 50 to 55%, and 55 to 60%, i.e. 50 to 60%, etc.

According to a preferred embodiment, the heat transfer composition comprises more than 50% by weight of azeotropic composition according to the invention, and in particular 50% to 99% by weight, relative to the total weight of the heat transfer composition.

In the heat transfer composition according to the invention, the mass lubricant proportion, and in particular polyol ester-based lubricant (POE), can represent, in particular, 1 to 5% of the composition; or 5 to 10% of the composition; or 10 to 15% of the composition; or 15 to 20% of the composition; or 20 to 25% of the composition; or 25 to 30% of the composition; or 30 to 35% of the composition; or 35 to 40% of the composition; or 40 to 45% of the composition; or 45 to 50% of the composition; or 50 to 55% of the composition; or 55 to 60% of the composition; or 60 to 65% of the composition; or 65 to 70% of the composition; or 70 to 75% of the composition; or 75 to 80% of the composition; or 80 to 85% of the composition; or 85 to 90% of the composition; or 90 to 95% of the composition; or 95 to 99% of the composition; or 99 to 99.5% of the composition; or 99.5 to 99.9% of the composition; or more than 99.9% of the composition. The lubricant content can also vary in several of the ranges above: for example, 50 to 55%, and 55 to 60%, i.e. 50 to 60%, etc.

Uses

The present invention relates to the use of a quasi-azeotropic composition such as defined above as a heat transfer fluid.

The present invention also relates to the use of a quasi-azeotropic composition or a heat transfer composition according to the invention, in a heat transfer system containing a steam compression circuit.

According to an embodiment, the heat transfer system is:
an air conditioning system; or
a refrigeration system; or
a freezing system; or
a heat pump system.

The present invention also relates to a heat transfer method based on the use of a heat transfer installation containing a steam compression circuit that comprises the quasi-azeotropic composition or the heat transfer composition according to the invention. The heat transfer method can be a method for heating or cooling a fluid or a body.

The quasi-azeotropic composition or the heat transfer composition can also be used in the method for producing mechanical work or electricity, in particular under a Rankine cycle.

The invention also relates to a heat transfer installation comprising a steam compression circuit that contains the quasi-azeotropic composition or the heat transfer composition according to the invention.

According to an embodiment, this installation is selected from the mobile or stationary refrigeration, heat (heat pump), air conditioning and freezing installations, and combustion engines.

In particular, this can be a heat pump installation, in which case the fluid or body that is heated (generally air and possibly one or more products, objects or bodies) is located in a local or a vehicle cabin (for a mobile installation). According to a preferred embodiment, this is an air conditioning installation, in which case the fluid or body that is cooled (generally air and possibly one or more products, objects or bodies) is located in a local or vehicle cabin (for a mobile installation). It can be a refrigeration installation or a freezing installation (or cryogenic installation), in which case the fluid or body that it cooled generally comprises air and one or more products, objects or bodies, located in a local or a container.

In particular, the heat transfer installation is a heat pump, or an air conditioning installation, for example, a chiller.

The invention also relates to method for heating or cooling a fluid or a body by means of a steam compression circuit containing a heat transfer fluid or a heat transfer composition, said method successively comprising the evaporation of the fluid or the heat transfer composition, the compression of the fluid or the heat transfer composition, the condensation of the fluid or the heat transfer composition, and the expansion of the fluid or the heat transfer composition, wherein the heat transfer fluid is the quasi-azeotropic composition according to the invention, or the heat transfer composition is that described above.

The invention also relates to a method for producing electricity by means of a combustion engine, said method successively comprising the evaporation of the heat transfer fluid or a heat transfer composition, the expansion of the fluid or the heat transfer composition in a turbine making it possible to generate electricity, the condensation of the fluid or the heat transfer composition, and the compression of the fluid or the heat transfer composition, wherein the heat transfer fluid is the quasi-azeotropic composition according to the invention and the heat transfer composition is that described above.

The steam compression circuit, containing a fluid or a heat transfer composition according to the invention, comprises at least one evaporator, a compressor, preferably of the screw type, a condenser or an expander, as well as transport lines of the fluid or of the heat transfer composition between these elements. The evaporator and the condenser comprise a heat exchanger making it possible for heat exchange between the fluid or the heat transfer composition and another fluid or body.

The evaporator used in the context of the invention can be an overheating evaporator or a flooded evaporator. In an overheating evaporator, all of the fluid or the heat transfer composition mentioned above is evaporated at the outlet of the evaporator, and the steam phase is overheated.

In a flooded evaporator, the fluid/the heat transfer composition in liquid form does not evaporate completely. A flooded evaporator comprises a liquid phase and steam phase separator.

As a compressor, in particular a centrifugal compressor with one or more stages or a centrifugal mini-compressor can be used. Rotating piston or screw compressors can also be used.

According to another embodiment, the steam compression circuit comprises a screw compressor, preferably a two-screw or one-screw compressor. In particular, the steam compression circuit comprises a two-screw compressor, able to implement a significant oil flow, for example up to 6.3 L/s.

A centrifugal compressor is characterised in that it uses rotating elements to radially accelerate the fluid or the heat transfer composition; it typically comprises at least one rotor and a diffuser housed in an enclosure. The heat transfer fluid or the heat transfer composition is introduced at the centre of the rotor and circulates towards the periphery of the rotor by undergoing acceleration. Thus, on the one hand, the static pressure increases in the rotor, and in particular on the other hand, at the level of the diffuser, the speed is converted into an increase of the static pressure. Each rotor/diffuser assembly constitutes a stage of the compressor. The centrifugal compressor can comprise 1 to 12 stages, according to the desired final pressure and the fluid volume to be treated.

The compression rate is defined as being the ratio of the absolute pressure of the fluid/heat transfer composition at the outlet over the absolute pressure of said fluid or of said composition at the inlet.

The rotation speed for large centrifugal compressors ranges from 3000 to 7000 revolutions per minute. Small centrifugal compressors (or centrifugal mini-compressors) generally function at a rotation speed ranging from 40000 to 70000 revolutions per minute and comprise a small-sized rotor (generally less than 0.15 m).

A rotor with several stages can be used to improve the efficiency of the compressor and limit the energy cost (relative to a rotor with one single stage). For a two-stage system, the outlet of the first stage of the rotor supplies the inlet of the second rotor. The two rotors can be mounted on one single axis. Each stage can supply a compression rate of the fluid of around 4 over 1, i.e. that the absolute outlet pressure can be equal to around four times the absolute pressure to the suctioning. Examples of centrifugal compressors with two stages, in particular for motor vehicle applications, are described in documents U.S. Pat. Nos. 5,065,990 and 5,363,674.

The centrifugal compressor can be driven by an electric engine or by a gas turbine (for example, supplied by exhaust gases of a vehicle, for mobile applications) or by gearing.

The installation can comprise a coupling of the expander with a turbine to generate electricity (Rankine cycle).

The installation can also possibly comprise at least one heat transfer fluid circuit used to transmit the heat (with or without state change) between the heat transfer fluid circuit or the heat transfer composition, and the fluid or body to be heated or cooled.

The installation can also possibly comprise two steam compression circuits (or more), containing identical or separate fluids/heat transfer compositions. For example, the steam compression circuits can be coupled together.

The steam compression circuit functions according to a conventional steam compression cycle. The cycle comprises the state change of the fluid/heat transfer composition of a liquid phase (or two liquid/steam phases) towards a steam phase at a relatively low pressure, then the compression of the fluid/steam phase composition up to a relatively high pressure, the state change (condensation) of the fluid/heat transfer composition of the steam phase towards the liquid phase at a relatively high pressure, and the reduction of the pressure to restart the cycle.

In the case of a cooling method, the heat coming from the fluid or from the body that is cooled (directly or indirectly, via a heat transfer fluid) is absorbed by the fluid/the heat transfer composition, during the evaporation of the latter, at a relatively low temperature relative to the environment. The cooling methods comprise air conditioning methods (with mobile installations, for example in vehicles, or stationary objects), refrigeration and freezing or cryogenics. In the field of air conditioning, domestic, commercial or industrial air conditioning can be mentioned, where the equipment used is either chillers, or direct expansion equipment. In the refrigeration field, domestic, commercial refrigeration, cold chambers, the agribusiness industry, refrigerated transport (lorries, boats) can be mentioned.

In the case of a heating method, heat is transferred (directly or indirectly, via a heat transfer fluid) from the fluid/the heat transfer composition, during the condensation thereof, to the fluid or to the body that is heated, at a relatively high temperature relative to the environment. The installation making it possible to implement the heat transfer is called, in this case, “heat pump”. These can, in particular, be medium and high temperature heat pumps.

It is possible to use any type of heat exchanger to implement compositions (azeotropic or heat transfer) according to the invention, and in particular co-current heat exchangers, preferably counter-current heat exchangers.

However, according to a preferred embodiment, the invention provides that the cooling and heating methods, and the corresponding installations, comprise a counter-current heat exchanger, either with a condenser, or with an evaporator. Indeed, the compositions according to the invention (quasi-azeotropic composition or heat transfer composition defined above) are particularly effective with counter-current heat exchangers. Preferably, both the evaporator and the condenser comprise a counter-current heat exchanger.

According to the invention, the term “counter-current heat exchanger” is used to describe a heat exchanger wherein the heat is exchanged between a first fluid and a second fluid, the first fluid at the outlet of the exchanger exchanging the heat with the second fluid at the outlet of the exchanger, and the first fluid at the outlet of the exchanger exchanging the heat with the second fluid at the inlet of the exchanger.

For example, the counter-current heat exchangers comprise devices wherein the flow of the first fluid and the flow of the second fluid are in opposite or almost opposite directions. The exchangers functioning in cross-current with a counter-current trend mode are also part of the counter-current heat exchangers in the sense of the present application.

In “low-temperature refrigeration” methods, the inlet temperature of the composition according to the invention (quasi-azeotropic or heat transfer composition) to the evaporator is preferably −45° C. to −15° C., in particular −40° C. to −20° C., more specifically preferably −35° C. to −25° C. and for example, of around −30° C.; and the temperature of the start of the condensation of the composition according to the invention (quasi-azeotropic or heat transfer composition) to the condenser is preferably 25° C. to 80° C., in particular 30° C. to 60° C., more specifically preferably 35° C. to 55° C. and for example, of around 40° C.

In “moderate temperature cooling” methods, the inlet temperature of the composition according to the invention (quasi-azeotropic or heat transfer composition) to the evaporator is preferably −20° C. to 10° C., in particular −15° C. to 5° C., more specifically preferably −10° C. to 0° C. and for example, of around −5° C.; and the temperature of the start of the condensation of the composition according to the invention (quasi-azeotropic or heat transfer composition) to the condenser is preferably 25° C. to 80° C., in particular 30° C. to 60° C., more specifically preferably 35° C. to 55° C. and for example, of around 50° C. These methods can be refrigeration or air conditioning methods.

In “moderate temperature heating” methods, the inlet temperature of the composition according to the invention (quasi-azeotropic or heat transfer composition) to the evaporator is preferably −20° C. to 10° C., in particular −15° C. to 5° C., more specifically preferably −10° C. to 0° C. and for example, of around −5° C.; and the temperature of the start of the condensation of the composition according to the invention (quasi-azeotropic or heat transfer composition) to the condenser is preferably 25° C. to 80° C., in particular 30° C. to 60° C., more specifically preferably 35° C. to 55° C. and for example, of around 50° C.

The compositions according to the invention are particularly useful in refrigerated transport.

Any movement of perishable products in a refrigerated space is considered as refrigerated transport. Food or pharmaceutical products represent a significant portion of perishable products.

The refrigerated transport can be carried out by lorry, rail or boat, possibly using multiplatform containers which adapt equally well to lorries, trains, or boats.

In refrigerated transport, the temperature of refrigerated spaces is of between −30° C. and 16° C. The refrigerant load in the transport by lorry, rail or multiplatform containers varies between 4 kg and 8 kg of refrigerant. The installations in boats can contain between 100 kg and 500 kg.

The operating temperatures of the refrigerant installations are a function of the refrigeration temperature needs and external climate conditions. The same refrigerant installation must be capable of covering a wide range of temperatures, between −30° C. and 16° C., and operate just as well in cold climates as it does in hot climates.

The most limiting evaporation temperature condition is −30° C.

The compositions according to the invention can be used to replace various heat transfer fluids in various heat transfer applications, such as 1,1,1,2-tetrafluoroethane (R134a).

The present invention also relates to the use of quasi-azeotropic compositions according to the invention, by replacing R134a in the refrigeration and/or in the heat pumps.

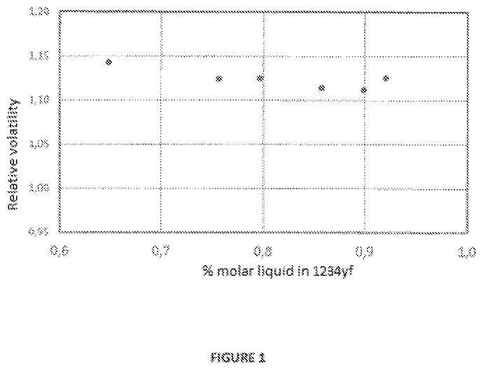

FIG. 1 is a graph illustrating the relative volatility of a composition of HFO-1234yf and trans-1,3,3,3-tetrafluoropropene according to the liquid molar fraction thereof respective to T=60° C. (±0.1° C.).

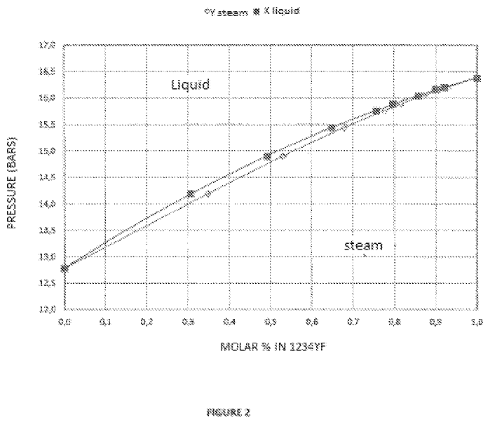

FIG. 2 is a graph illustrating the liquid/steam equilibrium curve of the mixture HFO-1234yf and trans-1,3,3,3-tetrafluoropropene according to the liquid molar fraction thereof respective to T=60° C. (±0.1° C.).

The following examples illustrate the invention, without however limiting it.

### EXAMPLES

In the following tables, “Tsat evap” means the temperature of the steam saturated fluid temperature at the outlet of the evaporator, “Tinlet evap” means the temperature of the fluid at the inlet of the evaporator, “T outlet comp” means the temperature of the fluid at the outlet of the compressor, “T sat liq cond” means the temperature of the liquid saturated fluid at the outlet of the condenser, “T sat ste cond” means the temperature of the steam saturated fluid at the condenser, “Pevap” means the pressure of the fluid in the evaporator, “Pcond” means the pressure of the fluid in the condenser, “Tslide evap” means the temperature slide at the evaporator.

COP: performance coefficient and is defined, when relating to a refrigeration system as being the useful cold power supplied by the system over the power brought or consumed by the system.

Isentropic efficiency of the compressor: this is the ratio between the actual energy transmitted to the fluid and the isentropic energy. This isentropic efficiency is a function of the compression rate. It is determined according to a typical efficiency curve. According to the “Handbook of air conditioning and refrigeration. Shan K. Wang”.

Consider a heat pump installation in heating mode, with an internal exchanger, which operates between an average evaporation temperature at −20° C., an average condensation temperature at 30° C., an overheating of 17° C.

| | | | | Temperature (° C.) | | | | | | | | |
|---|---|---|---|---|---|---|---|---|---|---|---|---|
| | | | | | | | T | T | | | | |
| | | | | | T | T | sat | sat | T | | | |
| | | P (bar) | | Tinlet | sat | outlet | ste | liq | slide | Pressure | % | % |
| | | Pcond | Pevap | evap | evap | comp | cond | cond | evap | ratio | CAP | COP |
| R134a | | 7.7 | 1.3 | −20 | −20 | 65 | 30 | 30 | 0.0 | 5.8 | 100 | 100 |
| HFO- | HFO- | | | | | | | | | | | |
| 1234yf | 1234ze | | | | | | | | | | | |
| 95 | 5 | 7.8 | 1.5 | −20 | −20 | 51 | 30 | 30 | 0.0 | 5.2 | 102 | 101 |
| 90 | 10 | 7.8 | 1.5 | −20 | −20 | 51 | 30 | 30 | 0.1 | 5.2 | 101 | 101 |
| 85 | 15 | 7.7 | 1.5 | −20 | −20 | 52 | 30 | 30 | 0.2 | 5.3 | 100 | 101 |
| 80 | 20 | 7.6 | 1.4 | −20 | −20 | 52 | 30 | 30 | 0.2 | 5.3 | 99 | 101 |
| 75 | 25 | 7.6 | 1.4 | −20 | −20 | 52 | 30 | 30 | 0.3 | 5.3 | 98 | 101 |
| 70 | 30 | 7.5 | 1.4 | −20 | −20 | 52 | 30 | 30 | 0.4 | 5.4 | 97 | 101 |
| 65 | 35 | 7.4 | 1.4 | −20 | −20 | 53 | 30 | 30 | 0.5 | 5.4 | 96 | 101 |
| 60 | 40 | 7.3 | 1.3 | −20 | −20 | 53 | 30 | 30 | 0.7 | 5.5 | 94 | 101 |

The table reveals that the compositions of the invention have advantageously a better performance coefficient COP relative to R134a.

Furthermore, the compositions of the invention have advantageously an outlet temperature of the compressor less than that of R134a. Thus, the compositions according to the invention can make it possible to replace R134a without modification of the technology of the compressors. This also makes it possible advantageously to limit the mechanical stresses on the compressors, and to limit the heating thereof.

1. Quasi-azeotropic composition comprising 60 mol % to 99.9 mol % of 2,3,3,3-tetrafluoropropene, and 0.1 mol % to 40 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

2. Composition according to claim 1, comprising 60 mol % to 98.9 mol % of 2,3,3,3-tetrafluoropropene, and 1.1 mol % to 40 mol % of trans-1,3,3,3-terafluoropropene, relative to the total number of moles of the composition, said quasi-azeotropic composition having a boiling point of between 45° C. and 80° C., at a pressure of between 1 and 50 bar abs.

3. Composition according to claim 1, comprising 70 mol % to 99.9 mol % of 2,3,3,3-tetrafluoropropene, and 0.1 mol % to 30 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

4. Composition according to claim 1, comprising 80 mol % to 99.9 mol % of 2,3,3,3-tetrafluoropropene, and 0.1 mol % to 20 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

5. Composition according to claim 1, comprising 85 mol % to 95 mol % of 2,3,3,3-tetrafluoropropene, and 5 mol % to 15 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

6. Composition according to claim 1, comprising 88 mol % to 93 mol % of 2,3,3,3-tetrafluoropropene, and 7 mol % to 12 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

7. Composition according to claim 1, comprising 64 mol % to 95 mol % of 2,3,3,3-tetrafluoropropene and 5 mol % to 36 mol % of trans-1,3,3,3-tetrafluoropropene, said composition having a boiling point of 60° C. (±0.1° C.), at a pressure of between 15 and 17 bar abs (±0.5%).

8. Composition according to claim 1, selected from the group consisting of:
quasi-azeotropic composition comprising 65 mol % (±3%) of 2,3,3,3-tetrafluoropropene and 35 mol % (±3%) of trans-1,3,3,3-tetrafluoropropene, said composition having a boiling point of 60° C. (±0.1° C.), at a pressure of between 15 and 17 bar abs (±0.5%);
quasi-azeotropic composition comprising 75 mol % (±3%) of 2,3,3,3-tetrafluoropropene and 25 mol % (±3%) of trans-1,3,3,3-tetrafluoropropene, said composition having a boiling point of 60° C. (±0.1° C.), at a pressure of between 15 and 17 bar abs (±0.5%);
quasi-azeotropic composition comprising 80 mol % (±3%) of 2,3,3,3-tetrafluoropropene and 20 mol % (±3%) of trans-1,3,3,3-tetrafluoropropene, said composition having a boiling point of 60° C. (±0.1° C.), at a pressure of between 15 and 17 bar abs (±0.5%);
quasi-azeotropic composition comprising 86 mol % (±3%) of 2,3,3,3-tetrafluoropropene and 14 mol % (±3%) of trans-1,3,3,3-tetrafluoropropene, said composition having a boiling point of 60° C. (±0.1° C.), at a pressure of between 15 and 17 bar abs (±0.5%);
quasi-azeotropic composition comprising 90 mol % (±3%) of 2,3,3,3-tetrafluoropropene and 10 mol % (±3%) of trans-1,3,3,3-tetrafluoropropene, said composition having a boiling point of 60° C. (±0.1° C.), at a pressure of between 15 and 17 bar abs (±0.5%); and,
quasi-azeotropic composition comprising 92 mol % (±3%) of 2,3,3,3-tetrafluoropropene and 8 mol % (±3%) of trans-1,3,3,3-tetrafluoropropene, said composition having a boiling point of 60° C. (±0.1° C.), at a pressure of between 15 and 17 bar abs (±0.5%).

9. Heat transfer composition comprising the quasi-azeotropic composition according to claim 1, and at least one additive selected from the group consisting of nanoparticles, stabilisers, surfactants, tracing agents, fluorescent agents, odorant agents, lubricants, and solubilisation agents, and combinations thereof.

10. Heat transfer installation comprising a steam compression circuit containing a quasi-azeotropic composition according to claim 3, or a heat transfer composition comprising 60 mol % to 99.9 mol % of 2,3,3,3-tetrafluoropropene, and 0.1 mol % to 40 mol % of trans-1,3,3,3-tetrafluoropropene, relative to the total number of moles of the composition, and at least one additive selected from the group consisting of nanoparticles, stabilisers, surfactants, tracing agents, fluorescent agents, odorant agents, lubricants, and solubilisation agents, and combinations thereof said heat transfer composition having a boiling point of between 45° C. and 80° C., at a pressure of between 1 and 50 bar.

11. Installation according to claim 10, selected from the mobile or stationary heating installations relying on a heat pump, air conditioning, refrigeration, freezing and combustion engines.

12. Method for producing electricity by means of a combustion engine, said method successively comprising
the evaporation of the heat transfer fluid or a heat transfer composition,
the expansion of the fluid or the heat transfer composition in a turbine making it possible to generate electricity,
the condensation of the fluid or the heat transfer composition and the compression of the fluid or the heat transfer composition,
wherein the heat transfer fluid is the quasi-azeotropic composition according to claim 2, and the heat transfer composition comprises 60 mol % to 99.9 mol % of 2,3,3,3-tetrafluoropropene, and 0.1 mol % to 40 mol % of trans-1,3,3,3-tetrafluoropropene, relative to the total number of moles of the composition, and at least one additive selected from the group consisting of nanoparticles, stabilisers, surfactants, tracing agents, fluorescent agents, odorant agents, lubricants, and solubilisation agents, and combinations thereof said heat transfer composition having a boiling point of between 45° C. and 80° C., at a pressure of between 1 and 50 bar abs.

13. Method for heating or cooling a fluid or a body by means of a steam compression circuit containing a heat transfer fluid or a heat transfer composition, said method successively comprising
the evaporation of the fluid or the heat transfer composition,
the compression of the fluid or the heat transfer composition,
the condensation of the fluid or the heat transfer composition, and
the expansion of the fluid or the heat transfer composition,
wherein the heat transfer fluid is the quasi-azeotropic composition according to claim 3, and the heat transfer composition comprises 60 mol % to 99.9 mol % of 2,3,3,3-tetrafluoropropene, and 0.1 mol % to 40 mol % of trans-1,3,3,3-tetrafluoropropene, relative to the total number of moles of the composition, and at least one additive selected from the group consisting of nanoparticles, stabilisers, surfactants, tracing agents, fluorescent agents, odorant agents, lubricants, and solubilisation agents, and combinations thereof said heat transfer composition having a boiling point of between 45° C. and 80° C., at a pressure of between 1 and 50 bar abs.

14. Composition according to claim 1, comprising 60 mol % to 99.9 mol % of 2,3,3,3-tetrafluoropropene, and 0.1 mol % to 40 mol % of trans-1,3,3,3-tetrafluoropropene, relative to the total number of moles of the composition, said quasi-azeotropic composition having a boiling point of between 45° C. and 80° C., at a pressure of between 10 and 40 bar abs.

15. Composition according to claim 1 having a boiling point of between 45° C. and 80° C. and at a pressure of between 12 and 20 bar abs.

16. Composition according to claim 1 having a boiling point of between 45° C. and 80° C. and at a pressure of between 10 and 40 bar abs.

17. Composition according to claim 1, comprising 71 mol % to 98.9 mol % of 2,3,3,3-tetrafluoropropene, and 1.1 mol % to 29 mol % of trans-1,3,3,3-tetrafluoropropene relative to the total number of moles of the composition, said quasi-azeotropic composition having a boiling point of between 45° C. and 80° C., at a pressure of between 1 and 50 bar abs.

18. Composition according to claim 1, comprising 71 mol % to 98 mol % of 2,3,3,3-tetrafluoropropene, and 2 mol % to 29 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

19. Composition according to claim 1, comprising 75 mol % to 98 mol % of 2,3,3,3-tetrafluoropropene, and 2 mol % to 25 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.

20. Composition according to claim 1, comprising 80 mol % to 98 mol % of 2,3,3,3-tetrafluoropropene, and 2 mol % to 20 mol % of trans-1,3,3,3-tetrafluoropropene, relative to the total number of moles of the composition, said quasi-azeotropic composition having a boiling point of between 45° C. and 80° C., at a pressure of between 1 and 50 bar abs.
